(19) United States
(12) Patent Application Publication
(10) Pub. No.: US 2015/0287393 A1
(43) Pub. Date: Oct. 8, 2015

(54) METHOD OF DRIVING ORGANIC LIGHT EMITTING DISPLAY DEVICE

(71) Applicant: SAMSUNG DISPLAY CO., LTD., Yongin-City (KR)

(72) Inventor: Sang-Myeon Han, Yongin-City (KR)

(21) Appl. No.: 14/658,112

(22) Filed: Mar. 13, 2015

(30) Foreign Application Priority Data
Apr. 7, 2014 (JP) 10-2014-0041167

(51) Int. Cl. G09G 5/18; G09G 3/32; G06T 1/60

(52) U.S. Cl. CPC G09G 5/18; G06T 1/60; G09G 3/3208

(57) ABSTRACT

A method for driving an organic light emitting display device includes: storing, during a period of at least one normal frame, a voltage corresponding to a data signal in a pixel; and driving, during a period of k (k is a natural number of one or more) continuous frames arranged continuously after the period of the normal frame, the pixel in accordance with the data signal stored during the period of the at least one normal frame

### CROSS-REFERENCE TO RELATED APPLICATION

This application claims priority to and the benefit of Korean Patent Application No. 10-2014-0041167, filed on Apr. 7, 2014, in the Korean Intellectual Property Office, the entire contents of which are incorporated herein by reference in their entirety.

### BACKGROUND

1. Field

Aspects of embodiments of the present invention relate to a method for driving an organic light emitting display device.

2. Description of the Related Art

With the continued development of information technology, the importance of a display device that displays information to a user is being magnified. Thus, there is a growing tendency to use flat panel display (FPD) devices such as liquid crystal display (LCD) devices, organic light emitting display (OLED) devices, and plasma display panels (PDP).

### SUMMARY

Accordingly, embodiments of the present invention are directed to a method for driving an organic light emitting display device, which is capable of reducing or minimizing power consumption.

According to an embodiment of the present invention, a method for driving an organic light emitting display device includes storing, during a period of at least one normal frame, a voltage corresponding to a data signal in a pixel; and driving, during a period of k (k is a natural number of one or more) continuous frames arranged continuously after the period of the normal frame, the pixel in accordance with the data signal stored during the period of the at least one normal frame.

The pixel may include a first capacitor, a driving transistor, an organic light emitting diode, and a second capacitor, and the storing the voltage corresponding to the data signal during the at least one normal frame may include storing the voltage corresponding to the data signal in the first capacitor while sequentially providing a scan signal to the pixel; initializing a gate electrode of the driving transistor and an anode electrode of an organic light emitting diode to have a specific voltage; and concurrently storing the data signal, stored in the first capacitor, in the second capacitor.

The method may further include applying an off bias voltage to the driving transistor before the gate electrode of the driving transistor is initialized.

The organic light emitting display device may include a plurality of scan lines and a plurality of pixels comprising the pixel, the pixels being coupled to corresponding ones of the scan lines, each of the pixels including: a first capacitor, a driving transistor, an organic light emitting diode, and a second capacitor, and the normal frame may include a first normal frame configured to sequentially provide the scan signal to the scan lines while storing the voltage corresponding to the data signal in the first capacitor of corresponding ones of the pixels; and a second normal frame configured to initialize the gate electrode of the driving transistor and the anode electrode of the organic light emitting diode to a specific voltage, and to concurrently store the data signal, stored in the first capacitor, in the second capacitor.

The method may further include applying the off bias voltage to the driving transistor before the gate electrode of the driving transistor is initialized during a period of the second normal frame.

At least one of a first power source and a second power source may be configured to output a varying voltage, the first power source supplying a current to the pixel during a period of the first normal frame, the second power source being supplied with the current from the first power source.

At least one of a first power source and a second power source may be configured to output a varying voltage, the first power source storing the data signal to the second capacitor and then supplying the current to the pixel during the period of the second normal frame, the second power source being supplied with a current from the first power source.

During the period of the continuous frames, the pixel may be configured to store the data signal provided during a period of a previous normal frame while controlling a current supplied to the organic light emitting diode.

At least one of a first power source and a second power source may be configured to output a varying voltage, the first power source supplying a current to the pixel during the period of the continuous frames, the second power source being supplied with the current from the first power source.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a view illustrating an organic light emitting display device according to an embodiment of the present invention;

FIG. 2 is a view illustrating an embodiment of a pixel shown in FIG. 1;

FIG. 3 is a waveform diagram illustrating a method for driving the pixel according to an embodiment of the present invention;

FIG. 4 is a view illustrating a driving process performed by the driving method of FIG. 3;

FIG. 5 is a view illustrating a driving waveform of a continuous frame according to an embodiment of the present invention;

FIG. 6 is a view illustrating a low-frequency driving method according to a first embodiment of the present invention;

FIG. 7A is a waveform diagram illustrating a driving method of a first normal frame;

FIG. 7B is a waveform diagram illustrating a driving method of a second normal frame;

FIG. 8 is a view illustrating a low-frequency driving method according to a second embodiment of the present invention;

FIG. 9 is a view illustrating an embodiment of the invention including a varying process of a first power source; and

FIG. 10 is a view illustrating an embodiment of the invention including a varying process of a second power source.

### DETAILED DESCRIPTION

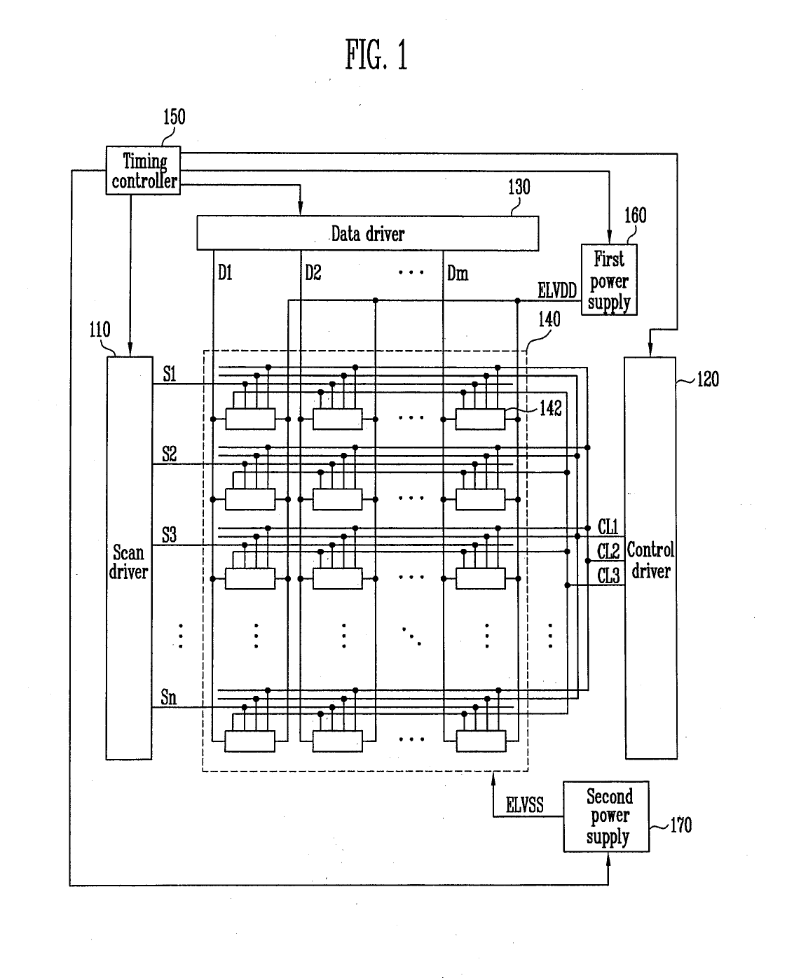

Hereinafter, preferred embodiments of the present invention will be described in more detail with reference to FIGS. 1, 2, 3, 4, 5, 6, 7, 8, 9, and 10.

FIG. 1 is a view illustrating an organic light emitting display device according to an embodiment of the present invention.

Referring to FIG. 1, the organic light emitting display device according to the embodiment of the present invention includes a pixel unit 140 having pixels 142 that are positioned (or located) in a region defined by scan lines S1 to Sn and data lines D1 to Dm, a scan driver 110 configured to drive (or supply scan signals to) the scan lines S1 to Sn, a data driver 130 configured to drive (or supply data signals to) the data lines D1 to Dm, a control driver 120 configured to drive a first control line CL1, a second control line CL2, and a third control line CL3 that are connected to the pixels 142 in common (e.g., connected to all of the pixels 142 in the pixel unit 140), a first power supply 160 configured to produce (or provide or generate or output) a first power source ELVDD, a second power supply 170 configured to produce (or provide or generate or output) a second power source ELVSS, and a timing controller 150 configured to control the scan driver 110, control driver 120, and data driver 130 as well as the first power supply 160 and second power supply 170.

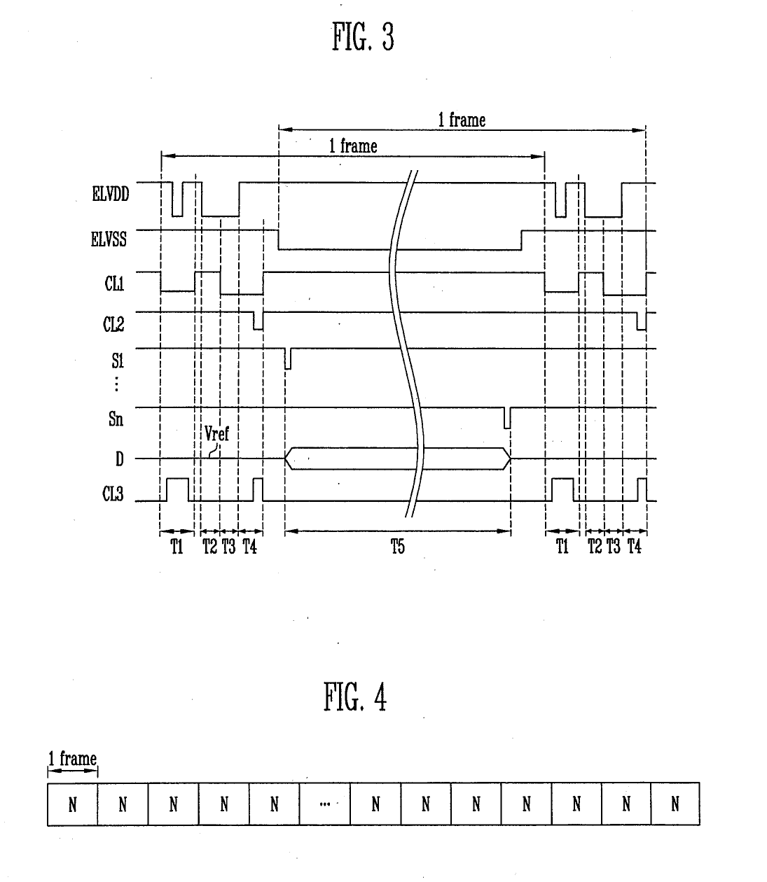

The scan driver 110 is configured to provide a scan signal (or scan signals) to the scan lines S1 to Sn. For example, as shown in FIG. 3, the scan driver 110 may sequentially provide the scan signal to the scan lines S1 to Sn during a fifth period T5 of one frame. Here, the scan signal is set to a voltage (e.g. low voltage) at which a transistor included in the pixels 142 may be turned on.

The control driver 120 provides a first control signal to the first control line CL1, provides a second control signal to the second control line CL2, and provides a third control signal to the third control line CL3. For example, the control driver 120 provides the first control signal to the first control line CL1 during the first period T1, the third period T3 and the fourth period T4 of one frame, and provides the second control signal to the second control line CL2 during some of the fourth period T4. Further, the control driver 120 provides the third control signal to the third control line CL3 during the first period T1 and some of the fourth period T4 of one frame. In this regard, the first and second control signals are set to a voltage at which the transistor included in the pixels 142 may be turned on, and the third control signal is set to a voltage at which the transistor included in the pixels 142 may be turned off.

The data driver 130 provides a data signal (or data signals) to the data lines D1 to Dm to be synchronized with the scan signal that is provided to the scan lines S1 to Sn during the fifth period T5. Further, the data driver 130 supplies a voltage of a reference power source Vref to the data lines D1 to Dm during a period between the first period T1 and the fourth period T4 except the fifth period T5. In this context, the voltage of the reference power source Vref may be variously set, and for example, may be set to a specific voltage in a voltage range of the data signal.

The first power supply 160 produces the voltage of the first power source ELVDD to supply it to the pixels 142. The first power supply 160 supplies a low level of first power source ELVDD during some of the first period T1, the second period T2, and the third period T3 of one frame, and supplies a high level of first power source ELVDD during the other periods of the frame (e.g., during some of the first period T1 and during periods T4 and T5). Here, the low level of first power source ELVDD is set to a low voltage so as to prevent or block a current from flowing in an organic light emitting diode (OLED) included in each of the pixels 142, while the high level of first power source ELVDD is set to a high voltage so as to allow a current to flow in the OLED included in each of the pixels 142.

The second power supply 170 produces the voltage of the second power source ELVSS to supply it to the pixels 142. The second power supply 170 supplies a low level of second power source ELVSS during the fifth period T5 of one frame, and supplies a high level of second power source ELVSS during other periods T1, T2, T3, and T4. Here, the low level of second power source ELVSS is set to a low voltage so as to allow a current to flow in the OLED included in each of the pixels 142, while the high level of second power source ELVSS is set to a high voltage so as to prevent or block a current from flowing in the OLED included in each of the pixels 142.

In the case of controlling the voltages of the first power source ELVDD and the second power source ELVSS as described above, the pixels 142 are set to an emitting state during the fifth period T5 of one frame, whereas they are set to a non-emitting state during other periods T1 to T4. In addition, the first power supply 160 may gradually decrease the voltage from the high level of first power source ELVDD to the low level of first power source ELVDD, or may gradually increase the voltage from the low level of first power source ELVDD to the high level of first power source ELVDD, according to the driving method. Likewise, the second power supply 170 may gradually decrease the voltage from the high level of second power source ELVSS to the low level of second power source ELVSS, or may gradually increase the voltage from the low level of second power source ELVSS to the high level of second power source ELVSS, according to the driving method. This will be described below in more detail.

The timing controller 150 is configured to control the scan driver 110, the control driver 120, the data driver 130, the first power supply 160, and the second power supply 170, in response to (or in accordance with) a synchronization signal provided from the outside (e.g., an external source).

The pixel unit 140 includes pixels 142 positioned or located in the region that is defined by the scan lines S1 to Sn and the data lines D1 to Dm. The pixels 142 are charged with (or store) a present (or current) data signal (e.g., data signal provided during a current frame) during the fifth period T5, and concurrently (or simultaneously) generate light of a luminance (e.g., a predetermined luminance) in response to (or in accordance with) a previous data signal (e.g., data signal provided to the pixel during a previous frame). For instance, the pixels 142 emit light while controlling a current flowing from the high level of first power source ELVDD through the OLED to the low level of second power source ELVSS, in response to the previous data signal, during the fifth period T5.

Although FIG. 1 illustrates, for the sake of convenience, that the control lines CL1, CL2, and CL3 are driven by the control driver 120, embodiments the present invention are not limited thereto. For example, at least one of the control lines CL1, CL2, and CL3 may be driven by the scan driver 110.

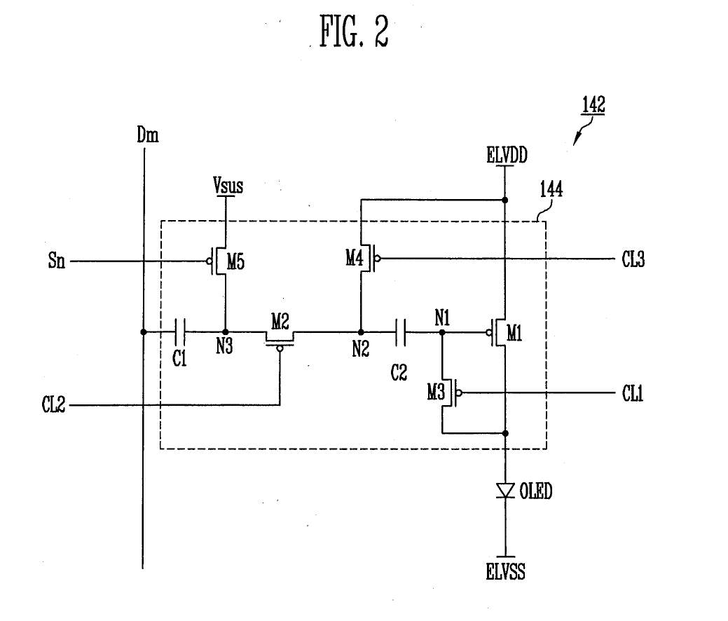

FIG. 2 is a view illustrating an embodiment of the pixel shown in FIG. 1. For the sake of convenience, FIG. 2 illustrates the pixel that is connected to an m-th data line Dm and an nth scan line Sn.

Referring to FIG. 2, the pixel 142 according to the first embodiment of the present invention includes an OLED, and a pixel circuit 144 configured to control a current that is supplied to the OLED.

An anode electrode of the OLED is connected to the pixel circuit 144, while a cathode electrode thereof is connected to the second power source ELVSS. Such an OLED generates light having a luminance (e.g., of a predetermined luminance) depending on (or in accordance with) the current supplied from the pixel circuit 144.

The pixel circuit 144 is configured to control the current supplied to the OLED in response to (or in accordance with) the previous data signal, in addition to storing the present (or current) data signal. To this end, the pixel circuit 144 includes first, second, third, fourth, and fifth transistors M1, M2, M3, M4, and M5, a first capacitor C1, and a second capacitor C2.

A first electrode of the first transistor M1 (e.g., driving transistor) is connected to the first power source ELVDD, while a second electrode thereof is connected to the anode electrode of the OLED. Further, a gate electrode of the first transistor M1 is connected to a first node N1. Such a first transistor M1 controls a current flowing from the first power source ELVDD through the OLED to the second power source ELVSS, in response to (or in accordance with) the voltage of the first node N1.

The second capacitor C2 is connected between the first node N1 and a second node N2. Such a second capacitor C2 stores a voltage corresponding to the previous data signal.

The second transistor M2 is connected between the second node N2 and a third node N3. Further, a gate electrode of the second transistor M2 is connected to the second control line CL2. Such a second transistor M2 is turned on when the second control signal is provided to the second control line CL2, thus electrically connecting the second node N2 to the third node N3.

The first capacitor C1 is connected between the data line Dm and the third node N3. Such a first capacitor C1 stores a voltage corresponding to the present data signal.

A third transistor M3 is connected between the first node N1 and a second electrode of the first transistor M1. Further, a gate electrode of the third transistor M3 is connected to the first control line CL1. Such a third transistor M3 is turned on when the first control signal is provided to the first control line CL1, thus electrically connecting the first node N1 to the second electrode of the first transistor M1. When the third transistor M3 is turned on, the first transistor M1 is connected in a diode form (e.g., first transistor M1 is diode-connected).

The fourth transistor M4 is connected between the first power source ELVDD and the second node N2. Further, a gate electrode of the fourth transistor M4 is connected to the third control line CL3. Such a fourth transistor M4 is turned off when the third control signal is provided to the third control line CL3, and is turned on in other cases. When the fourth transistor M4 is turned on, the voltage of the first power source ELVDD is supplied to the second node N2.

The fifth transistor M5 is connected between a third power source Vsus and the third node N3. Further, a gate electrode of the fifth transistor M5 is connected to the scan line Sn. Such a fifth transistor M5 is turned on when the scan signal is provided to the scan line Sn, thus supplying the voltage of the third power source Vsus to the third node N3. The third power source Vsus is a DC power source that supplies a reference voltage to allow the present data signal to be stored in the first capacitor C1, and may be set to various voltages.

FIG. 3 is a waveform diagram illustrating a method for driving the pixel according to an embodiment of the present invention.

Referring to FIG. 3, according to the embodiment of the present invention, one frame 1F includes the first period T1, the second period T2, the third period T3, the fourth period T4, and the fifth period T5. The first period T1 is the period when an off bias voltage is applied to the first transistor M1, the second period T2 and the third period T3 are the period when the first node N1 and the anode electrode of the OLED are initialized, the fourth period T4 is the period when the previous data signal is stored in the second capacitor C2, and the fifth period T5 is the period when the present data signal is charged (or stored) and, concurrently (or simultaneously), the OLED emits light in response to (or in accordance with) the previous data signal (e.g., the previous data signal stored in the second capacitor C2).

An operation according to an embodiment of the present invention will be described in more detail. First, the high level of second power source ELVSS is supplied during the first period T1, the second period T2, the third period T3, and the fourth period T4, so that the OLED of each of the pixels 142 is set to the non-emitting state. Further, the low level of first power source ELVDD is supplied during the first period T1, the second period T2, and the third period T3, and the high level of first power source ELVDD is supplied during the fourth period T4 and the fifth period T5. In this regard, the high level of first power source ELVDD is supplied during a period between the first period T1 and the second period T2.

In the first period T1, the first control signal is provided to the first control line CL1, the third control signal is provided to the third control line CL3, and the low level of first power source ELVDD is supplied from the first power supply 160. When the first control signal is provided to the first control line CL1, the third transistor M3 is turned on, so that the first node N1 is electrically connected to the anode electrode of the OLED. Here, the first transistor M1 is connected in the diode form (e.g., the first transistor M1 is diode-connected). When the third control signal is provided to the third control line CL3, the fourth transistor M4 is turned off.

Further, when the low level of first power source ELVDD is supplied, the first electrode of the first transistor M1 is reduced to the low level of first power source ELVDD. Because the first transistor M1 is connected in the diode form, the first transistor M1 is set to the off state, and thereby the first transistor M1 is initialized to the off bias state.

In the second period T2, the provision of the first and third control signals is interrupted (or stopped). Further, the low level of first power source ELVDD is supplied from the first power supply 160. When the provision of the third control signal to the third control line CL3 is interrupted (or stopped), the fourth transistor M4 is turned on.

When the fourth transistor M4 is turned on, the low voltage of the first power source ELVDD is supplied to the second node N2. As the low voltage of the first power source ELVDD is supplied to the second node N2, the voltage of the first node N1 is dropped by the coupling of the second capacitor C2. When the voltage of the first node N1 is dropped, the first transistor M1 is set to the ON state. In this case, the anode electrode of the OLED is approximately initialized to the low voltage of the first power source ELVDD.

In the third period T3, the low voltage of the first power source ELVDD is maintained, and, concurrently, the third transistor M3 is turned on in response to the first control signal provided to the first control line CL1. When the third transistor M3 is turned on, the voltage of the first node N1 is approximately initialized to the low voltage of the first power source ELVDD. That is, in the second period T2 and the third period T3, the first node N1 and the anode electrode of the OLED are approximately initialized to the low voltage of the first power source ELVDD.

In the fourth period T4, the first control signal is provided to the first control line CL1. Further, during the latter half of the fourth period T4, the second control signal is provided to the second control line CL2, and the third control signal is provided to the third control line CL3.

When the first control signal is provided to the first control line CL1, the third transistor M3 is turned on, so that the first transistor M1 is connected in the diode form (e.g., the first transistor M1 is diode-connected). Here, the first node N1 is set to a voltage that is obtained by subtracting the threshold voltage of the first transistor M1, which is a fixed (or absolute) value, from the high level of first power source ELVDD. In this regard, because no third control signal is provided to the third control line CL3 during the first half of the fourth period T4, the fourth transistor M4 is turned on. When the fourth transistor M4 is turned on, the high level of first power source ELVDD is supplied to the second node N2. As a result, a voltage corresponding to the threshold voltage of the first transistor M1 is stored in the second capacitor C2.

Subsequently, during the latter half of the fourth period T4, the second control signal is provided to the second control line CL2, so that the second transistor M2 is turned on, and the third control signal is provided to the third control line CL3, so that the fourth transistor M4 is turned off. When the second transistor M2 is turned on, the voltage of the previous data signal stored in the first capacitor C1 is supplied to the second node N2. Because the first node N1 is set to the voltage that is obtained by subtracting the threshold voltage of the first transistor M1, which is a fixed (or absolute) value, from the high level of first power source ELVDD, the previous data signal and the voltage corresponding to the threshold voltage of the first transistor M1 are stored in the second capacitor C2.

In the fifth period T5, the provision of the third control signal to the third control line CL3 is interrupted, so that the fourth transistor M4 is turned on. When the fourth transistor M4 is turned on, the second node N2 is set to the high voltage of the first power source ELVDD. Because the first control signal is not provided to the first control line CL1 during the fifth period T5, the third transistor M3 is turned off, and thereby the first node N1 is set to a floating state. Thus, the second capacitor C2 stably maintains the voltage that was charged (or stored) during the fourth period T4.

In addition, the low level of second power source ELVSS is supplied in the fifth period T5. When the low level of second power source ELVSS is supplied, the first transistor M1 included in each of the pixels 142 controls a current flowing from the high level of first power source ELVDD through the OLED to the low level of second power source ELVSS, in response to the voltage applied to the first node N1 of the first transistor. Then, each of the pixels 142 emits light in response to the previous data signal.

In the fifth period T5, the scan signal is sequentially provided to the scan lines S1 to Sn. When the scan signal is sequentially provided to the scan lines S1 to Sn, the fifth transistor M5 included in the pixels 142 on a horizontal-line basis is turned on. When the fifth transistor M5 is turned on, the voltage of the third power source Vsus is supplied to the third node N3.

At this time, the data signal is provided to the data lines D1 to Dm with a timing that is synchronized with the scan signal. Thus, the first capacitor C1 of each of the pixels 142 located at a horizontal line selected by the scan signal stores a voltage corresponding to the present data signal. During the fifth period T5, the scan signal is sequentially provided to each of the first scan line S1 through the n-th scan line Sn, and thus the voltage (or voltages) corresponding to the present data signal (or signals) is stored in the first capacitor C1 included in each of the pixels 142.

According to embodiments of the present invention, a gray level (or a predetermined grayscale or gray level) is realized while the above-mentioned process is repeated. In addition, according to embodiments of the present invention, one frame 1F may include various periods. For example, the first period T1, the second period T2, the third period T3, the fourth period T4 and the fifth period T5 may be considered as one frame 1F in this order. Alternatively, the fifth period T5, the first period T1, the second period T2, the third period T3 and the fourth period T4 may be considered as one frame 1F in this order.

FIG. 4 is a view illustrating a driving process performed by the driving method of FIG. 3.

Referring to FIG. 4, the organic light emitting display device is driven while repeating one frame 1F by the driving method of FIG. 3. Here, one frame 1F may include a period from the first period T1 through the fifth period T5, or a period from the fifth period T5 through the fourth period T4. For the sake of convenience, the below discussion will assume that one frame 1F includes the first period T1, the second period T2, the third period T3, the fourth period T4 and the fifth period T5 in this order, or includes the fifth period T5, the first period T1, the second period T2, the third period T3 and the fourth period T4 in this order, and that such a frame will be referred to as a normal frame N.

When the organic light emitting display device is driven with the normal frame N, the pixels 142 receive the present data signal, and generate (or emit) an amount of light (or a predetermined light) in response to (or in accordance with) the previous data signal. Further, light rays emitted from the respective pixels 142 are combined together, thus displaying an image (e.g., a predetermined image) on the pixel unit 140.

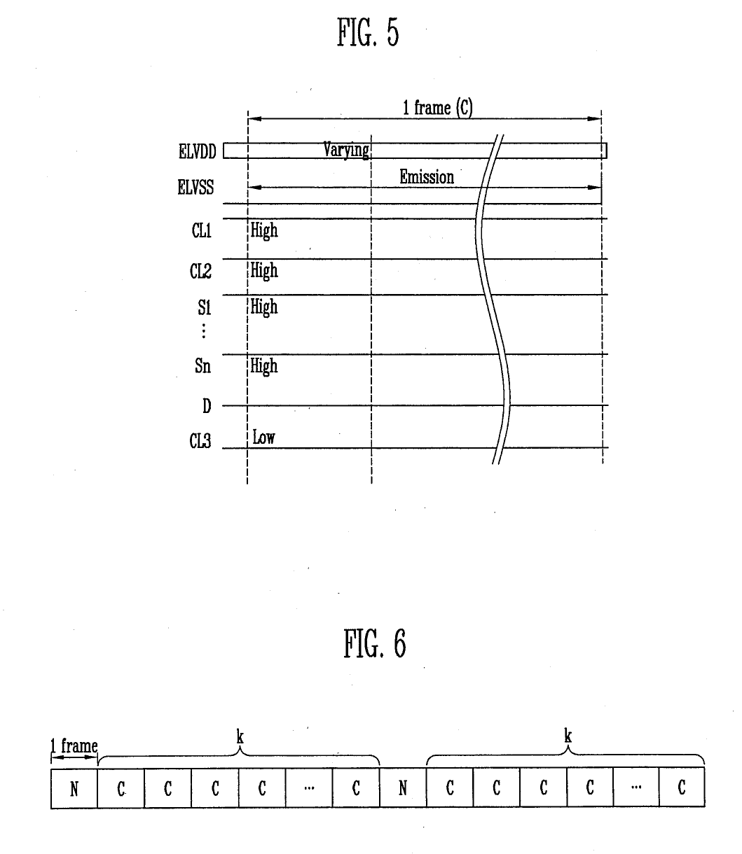

However, the normal frame N includes an off bias application period T1, an initialization period T2 and T3, a previous data storage period T4, and a present data storage and light emission period T5, so that power consumption is high. That is, when the organic light emitting display device is continuously driven with the normal frame N (data signal is provided to every frame), high power consumption is caused. In order to overcome the problem, embodiments of the present invention further include a continuous frame C as shown in FIG. 5.

FIG. 5 is a view illustrating a driving waveform of a continuous frame according to an embodiment of the present invention.

Referring to FIG. 5, the continuous frame C is set to have the same waveform as the fifth period T5 of the normal frame N except that no scan signal is provided to the scan lines S1 to Sn. During the period of the continuous frame C, the pixels 140 do not receive an additional data signal, and emit light in response to the data signal of the previous frame.

In addition, during the period of the continuous frame C, the voltage of the first power source ELVDD may be varied to be gradually increased or gradually reduced. This will be described below in more detail.

FIG. 6 is a view illustrating a low-frequency driving method according to a first embodiment of the present invention.

Referring to FIG. 6, in the low-frequency driving method according to the first embodiment of the present invention, k (where k is a natural number greater than or equal to one) continuous frames C are placed after the normal frame N. However, the normal frame N used in the low-frequency driving method is configured such that the driving waveform is arranged in the order of the fifth period T5, the first period T1, the second period T2, the third period T3 and the fourth period T4.

In the normal frame N, the data signal is stored in the first capacitor C1 during the fifth period T5, and the data signal is stored in the second capacitor C2 during a period from the first period T1 through the fourth period T4. The operation of the normal frame N remains the same as that shown in FIG. 3.

The pixel 142 storing the data signal in the normal frame N emits light in response to the data signal stored in the normal frame N during the period of the continuous frame C. Here, in the period of the continuous frame C, the control signals are not provided (e.g., a DC voltage is maintained), and an additional data signal is not provided (e.g., the provision of the data signal is performed at the interval of plural frames). Therefore, a driving frequency is lowered in response to the period of the continuous frame C, thus being capable of reducing or minimizing power consumption.

In other words, according to one embodiment of the present invention, the normal frame N is placed at intervals of k continuous frames C (e.g., one normal frame N for between k continuous frames C), and a certain image is displayed while the data signal is updated in the normal frame N, thus realizing a driving operation with a low driving frequency. For example, in the case of 60 Hz driving, when k is set to “1”, the driving operation may be performed with the driving frequency of 30 Hz, and when k is set to “2”, the driving operation may be performed with the driving frequency of 20 Hz. Likewise, in the case of 120 Hz driving, when k is set to “1”, the driving operation may be performed with the driving frequency of 60 Hz, and when k is set to “2”, the driving operation may be performed with the driving frequency of 40 Hz.

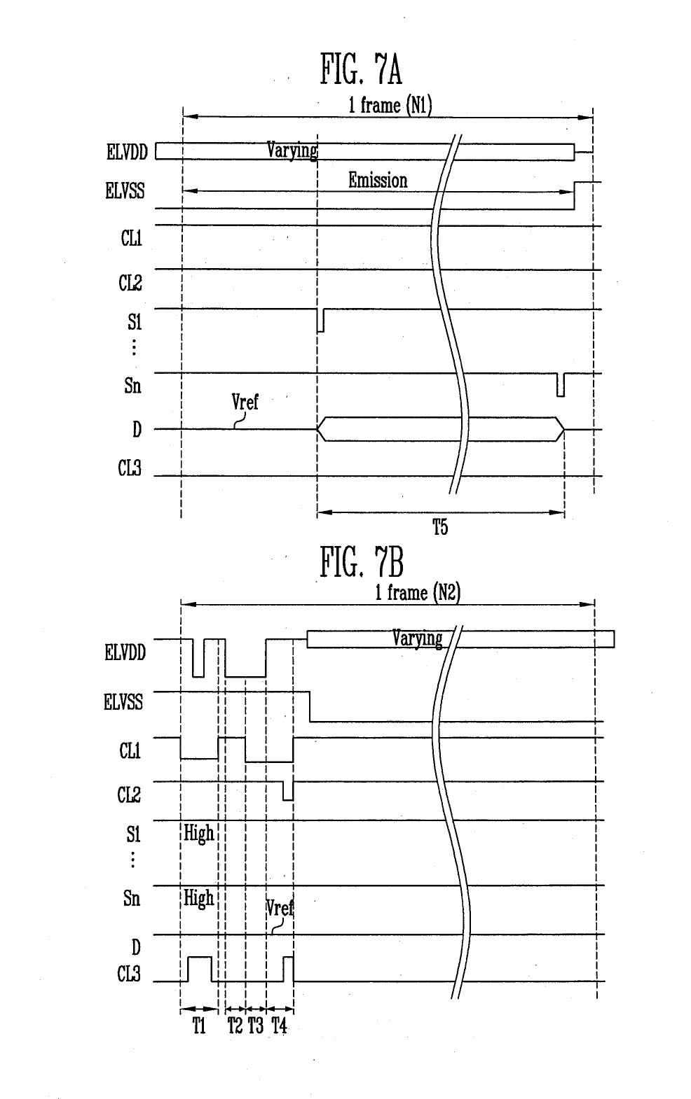

Further, in the low-frequency driving method of one embodiment of the present invention, the normal frame N may be implemented as a first normal frame N1 or a second normal frame N2, as shown in FIGS. 7A and 7B.

FIG. 7A is a waveform diagram illustrating the driving method of the first normal frame.

Referring to FIG. 7A, the first normal frame N1 is set to include only the fifth period T5 shown in FIG. 3. In other words, during the period of the first normal frame N1, the scan signal is sequentially provided to the scan lines S1 to Sn, and the voltage corresponding to the data signal is stored in the first capacitor C1 of each of the pixels 142.

In this case, no control signal is provided to the first control line CU to the third control line CL3. Further, the second power supply 170 supplies the low level of second power source ELVSS. Thus, during the period of the first normal frame N1, the pixels 142 store the present data signal and concurrently maintains the light emitting state in response to (or in accordance with) the data signal of the previous frame (e.g., the previous data signal). In addition, the first power source ELVDD is set to a voltage at which the pixels 142 may emit light, and may be varied to be gradually increased or reduced.

FIG. 7B is a waveform diagram illustrating a driving method of the second normal frame.

Referring to FIG. 7B, the second normal frame N2 is set to include only the first period T1 to the fourth period T4 shown in FIG. 3. In other words, in the period of the second normal frame N2, the following processes are included: the application of the off bias voltage to the first transistor M1 included in each of the pixels 142, the initialization of the first node N1 and the OLED, and the storage of the previous data signal in the second capacitor C2. In addition, the same waveform as the continuous frame C of FIG. 5 is applied to periods other than the first period T1 to the fourth period T4 in the second normal frame N2.

If the driving operation is performed with the first normal frame N1 or the second normal frame N2, it is possible to assign sufficient time to the respective periods T1 to T5, thus improving or guaranteeing operational stability.

FIG. 8 is a view illustrating a low-frequency driving method according to a second embodiment of the present invention.

Referring to FIG. 8, in the low-frequency driving method according to the second embodiment of the present invention, the first normal frame N1 and the second normal frame N2 are continuously arranged, and subsequently k continuous frames C are arranged.

In the first normal frame N1, the data signal is stored in the first capacitor C1. Further, in the second normal frame N2, the gate electrode of the first transistor M1 included in each of the pixels 142 is initialized, and the data signal is stored in the second capacitor C2. Indeed, the operation of the first normal frame N1 and the second normal frame N2 remains the same as that of FIG. 3.

The pixel 142 storing the data signal in the second normal frame N2 emits light during the period of the continuous frames C in response to (or in accordance with) the data signal stored in the second normal frame N2. In the period of the continuous frames C, the control signals are not provided (e.g. DC voltage is maintained), and an additional data signal is not provided. Thus, the driving frequency is lowered depending on the period of the continuous frames C, so that power consumption can be reduced or minimized.

FIG. 9 is a view illustrating an embodiment of a varying process of a first power source.

Referring to FIG. 9, when k continuous frames C are arranged in the low-frequency driving method, the luminance of the pixel 142 may vary due to a process variation (leakage current, manufacturing environment, etc.), a data signal, etc.

Therefore, according to one embodiment of the present invention, when the continuous frame C is arranged, the first power supply 160 may perform control such that the voltage is gradually decreased from the high level of first power source ELVDD to the low level of first power source ELVDD, and the voltage is gradually increased from the low level of first power source ELVDD to the high level of first power source ELVDD. In this regard, the voltage of the first power source ELVDD may be changed during the period of the continuous frame C of FIG. 5 or changed during the varying period of the first power source ELVDD shown in FIGS. 7A and 7B.

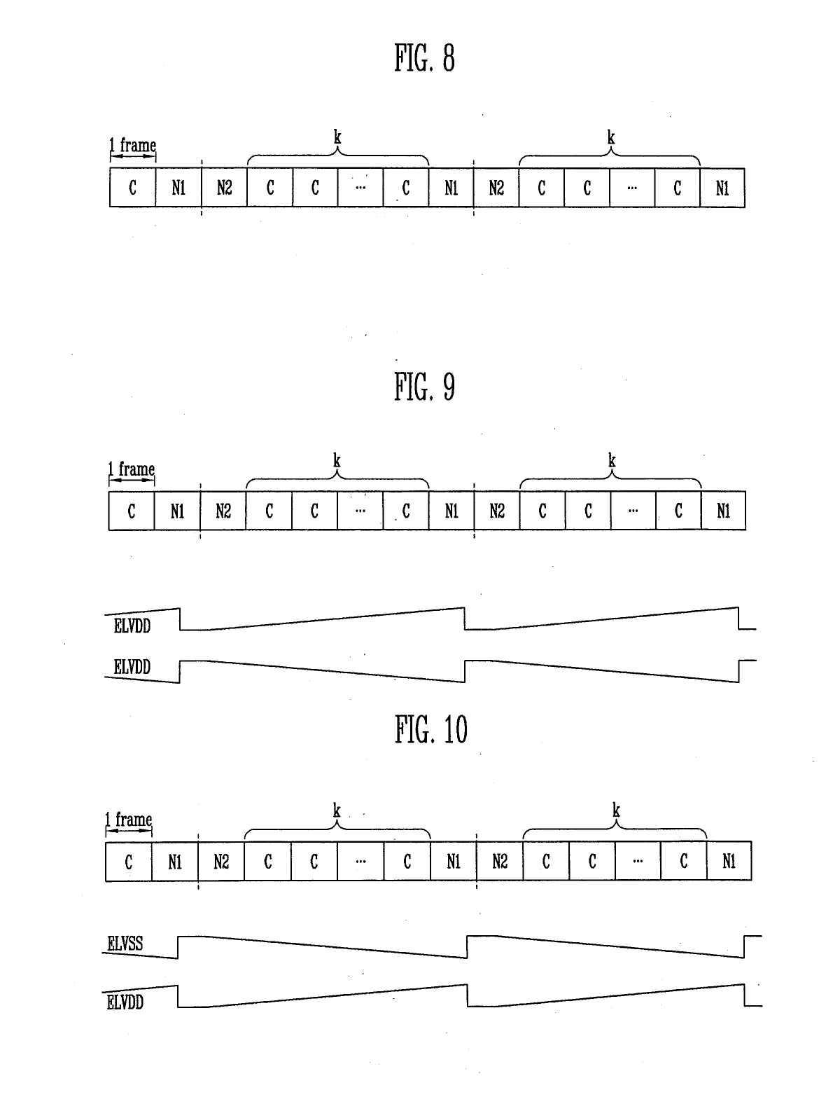

Although FIG. 9 illustrates that the first power source ELVDD is varied, embodiments of the present invention are not limited thereto. For example, according to one embodiment of the present invention, it is possible to control the voltage of the second power source ELVSS, as shown in FIG. 10. Indeed, according to one embodiment of the present invention, at least one of the first power source ELVDD and the second power source ELVSS may be controlled to allow an image of a desired luminance to be displayed on the pixel 142.

FIG. 10 is a view illustrating an embodiment of a varying process of a second power source.

Referring to FIG. 10, in the low-frequency driving method in which the continuous frames C are arranged, the second power supply 170 may perform control such that the voltage is gradually reduced from the high level of second power source ELVSS to the low level of second power source ELVSS, or the voltage is gradually increased from the low level of second power source ELVSS to the high level of second power source ELVSS. Here, the second power source ELVSS may change a voltage during the varying period of the first power source ELVDD illustrated in FIG. 9.

For the sake of convenience, the transistors are illustrated as PMOS transistors in the above description, but embodiments of the present invention are not limited thereto. In other words, the transistors may be formed as NMOS transistors.

Further, according to one embodiment of the present invention, the OLED may generate red, green, blue, or white light depending on a current. When the OLED generates the white light, it is possible to implement a color image using an additional color filter.

By way of summary and review, among the FPD devices, the organic light emitting display device displays images using the OLED that generates light through the recombination of electrons and holes. The organic light emitting display device is advantageous in that it has a high response speed and is driven with low power consumption.

The organic light emitting display device includes a plurality of pixels that are arranged in the matrix form at the intersections of the data lines, the scan lines, and the power lines. The pixels generally include the OLED, two or more transistors including the driving transistor, and one or more capacitors.

Such an organic light emitting display device is applied to various imaging devices including a television and various mobile devices including a mobile phone. Therefore, in order to allow the organic light emitting display device to be stably used for a lengthy period of time, a method capable of reducing or minimizing power consumption is desired.

The method for driving the organic light emitting display device according to an embodiment of the present invention allows light to be emitted while maintaining the data signal provided to a specific frame during the period of a plurality of frames, thus reducing or minimizing power consumption. Further, during the frame period when the same data signal is continuously maintained, the voltage of the first power source and/or the second power source is varied, thus being capable of displaying an image of a desired luminance.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims and equivalents thereof.

What is claimed is:

1. A method for driving an organic light emitting display device, comprising:
storing, during a period of at least one normal frame, a voltage corresponding to a data signal in a pixel; and
driving, during a period of k (k is a natural number of one or more) continuous frames arranged continuously after the period of the normal frame, the pixel in accordance with the data signal stored during the period of the at least one normal frame.

2. The method as claimed in claim 1,
wherein the pixel comprises:
a first capacitor;
a driving transistor;
an organic light emitting diode; and
a second capacitor, and
wherein the storing the voltage corresponding to the data signal during the at least one normal frame comprises:
storing the voltage corresponding to the data signal in the first capacitor while sequentially providing a scan signal to the pixel;
initializing a gate electrode of the driving transistor and an anode electrode of the organic light emitting diode to a specific voltage; and
concurrently storing the data signal, stored in the first capacitor, in the second capacitor.

3. The method as claimed in claim 2, further comprising:
applying an off bias voltage to the driving transistor before the gate electrode of the driving transistor is initialized.

4. The method as claimed in claim 1,
wherein the organic light emitting display device comprises:
a plurality of scan lines; and
a plurality of pixels comprising the pixel, the pixels being coupled to corresponding ones of the scan lines, each of the pixels comprising:
a first capacitor;
a driving transistor;
an organic light emitting diode; and
a second capacitor, and
wherein the normal frame comprises:
a first normal frame configured to sequentially provide the scan signal to the plurality of scan lines while storing the voltage corresponding to the data signal in the first capacitor of corresponding ones of the pixels; and
a second normal frame configured to initialize the gate electrode of the driving transistor and the anode electrode of the organic light emitting diode to a specific voltage, and to concurrently store the data signal, stored in the first capacitor, in the second capacitor.

5. The method as claimed in claim 4, further comprising:
applying the off bias voltage to the driving transistor before the gate electrode of the driving transistor is initialized during a period of the second normal frame.

6. The method as claimed in claim 4, wherein at least one of a first power source and a second power source is configured to output a varying voltage, the first power source supplying a current to the pixel during a period of the first normal frame, the second power source being supplied with the current from the first power source.

7. The method as claimed in claim 4, wherein at least one of a first power source and a second power source is configured to output a varying voltage, the first power source supplying the current to the pixel during the period of the second normal frame, the second power source being supplied with a current from the first power source.

8. The method as claimed in claim 1, wherein, during the period of the continuous frames, the pixel is configured to store the data signal provided during a period of a previous normal frame while controlling a current supplied to the organic light emitting diode.

9. The method as claimed in claim 1, wherein at least one of a first power source and a second power source is configured to output a varying voltage, the first power source supplying a current to the pixel during the period of the continuous frames, the second power source being supplied with the current from the first power source.
